(19) United States
(12) Patent Application Publication
(10) Pub. No.: US 2005/0086640 A1
(43) Pub. Date: Apr. 21, 2005

(54) Initiating execution of application programs on a data processing arrangement

(76) Inventors: Mikko Kolehmainen, Jarvenpaa (FI); Hannu Mettala, Lapinkyla (FI); Petri Niska, Helsinki (FI)

Correspondence Address: Crawford Maunu PLLC;Suite 390, 1270 Northland Drive, St. Paul, MN, 55120, US

(21) Appl. No.: 10/937,085

(22) Filed: Sep. 9, 2004

Related U.S. Application Data
(60) Provisional application No. 60/513,050, filed on Oct. 21, 2003.

(51) Int. Cl. G06F 9/44

(52) U.S. Cl. 717/120; 717/170; 717/165

(57) ABSTRACT

A method of initiating execution of an application program on a data processing arrangement involves determining computational resources required for execution of an application program. Computational resources available via the data processing arrangement are also determined. A precondition is determined based on whether the computational resources available via the data processing arrangement satisfy the computational resources required for execution of the application program. The application program is executed on the data processing arrangement if the precondition is satisfied.

This application claims the benefit of U.S. Provisional Application No. 60/513,050 filed 21 Oct. 2003, the content of which is incorporated herein by reference in its entirety.

### FIELD OF THE INVENTION

This invention relates in general to data processing, and more particularly to determining environments for the execution of software.

### BACKGROUND OF THE INVENTION

Most commonly used application software is prepared to run in a particular target environment. Typically this software includes binary programs that are compiled to run on a particular processor that is running a particular operating system. For example, a program with an EXE binary format may be compiled for an x86 compatible computer running the Windows™ operating system (OS). A Unix program compiled for the x86 may use the same processor instruction set as the Windows program, yet the Unix program cannot be run natively in Windows. Similarly, the Windows program cannot be run natively in a Linux™ or Unix™ environment. Native programs rely on many aspects of their target environment to run, including the binary formats required by the program loaders and available libraries and services.

Although most software is tied to a particular processor and OS, some software environments are designed from the ground-up to be platform independent. Programming languages such as Java™ and C# are designed to utilize special runtime environments. Java runs in a Java Virtual Machine (JVM) as part of the Java Runtime Environment (JRE). A C# program can be run in the Common Language Runtime (CLR). In both cases, the runtime environment provides features such as type-verification, memory “garbage collection,” error handling, and access to system resources. Java and C# programs themselves do not directly rely on any OS-specific features, therefore the programs can run anywhere the appropriate run-time environment is available. For example, the JRE has been ported to various popular computer architectures and operating systems. Therefore, Java programs can be successfully deployed in cross-platform environments. Although Java is widely used as an application programming language, Java has been primarily adopted as a server side product (e.g., Java Enterprise Edition).

Even when applications are designed for a single architecture, there may still be incompatibilities that keep some applications from running. Operating systems provide all manner of device drivers, services, inter-process communications mechanisms, libraries, data storage, and other data processing features that may be required in order for an application to run successfully. Just like a non-native application, these applications simply will not run if all the required capabilities are not available at runtime. In the future, it is expected that computing environments will become even more heterogeneous than they currently are, especially when the available resources and configurations are concerned. This will occur due to changes in hardware, software, and the end-uses devised by the consumers of these products. This is especially true when it comes to network environments.

An application designed to operate in a network environment may depend on various remote services and capabilities. These network services may include typical networking functions, such as domain name service and routers. Other network services are more transparent to the end user applications, such as remote procedure calls and accesses to networked file systems and databases. To the applications, it makes no difference if these latter services are provided locally or across a network, all that matters is that the service is operating correctly.

Due to the ever-increasing complexity of computer hardware and reliance on network services, the application programmer has more to worry about when trying to get an application to run. Even though extensive testing may be done in a development environment, there is a nearly infinite variety of environments in which the application may be deployed. Often, applications that fail to install or run in a target environment because services or capabilities that the application relies upon are non-existent or misconfigured. Therefore it is desirable to find a way to effectively manage the startup of software in these environments to ensure more successful operation.

### SUMMARY OF THE INVENTION

The present disclosure relates to initiating execution of an application program on a data processing arrangement. In one embodiment of the invention, a method involves determining computational resources required for execution of an application program. Computational resources available via the data processing arrangement are also determined. A precondition is determined based on whether the computational resources available via the data processing arrangement satisfy the computational resources required for execution of the application program. The application program is executed on the data processing arrangement if the precondition is satisfied.

In more particular embodiments, the method involves registering the computational resources available via the data processing arrangement in an execution environment rule base. Additionally, the computational resources required for execution of the application program may be registered in an application rule base. The method may involve forming deployment rules that map requirements of the application rule base to resources of the execution environment rule base. Determining the preconditions may further involve applying the deployment rules to the execution environment rule base and the application rule base.

In one configuration, determining the computational resources required for execution of the application program further involves utilizing a proxy interface of the application program. The proxy interface provides predefined rules for describing computational resources required for execution of the application program. In another configuration, determining the computational resources available via the data processing arrangement may involve utilizing a wrapper interface of the data processing arrangement. The wrapper interface provides predefined rules for describing computational resources available via the data processing arrangement. Determining the precondition may involve communicating between the proxy interface and the wrapper interface to determine whether the computational resources available via the data processing arrangement satisfy the computational resources required for execution of the application program.

In another configuration, communicating between the proxy interface of the application program and the wrapper interface of the data processing arrangement may involve creating a dynamic binding between the proxy interface and the wrapper interface prior to execution of the application program. The computational resources required for execution of the application program may include at least one of a processor type, an operating system, data communications primitives, a database, and a user interface.

In another embodiment of the present invention, a system includes at least one application, a plurality of computational resources, and a bootstrap controller. The bootstrap controller performs operations that include determining computational resource requirements for execution of the application, determining a set of computational resources that satisfy the computational resource requirements from the plurality of computational resources, and executing the application on the system if the computational resource requirements are satisfied.

In a more particular embodiment, the system also includes an execution environment rule base describing the plurality of computational resources and an application rule base describing the computational resource requirements for execution of the application. The bootstrap controller may be further configured to form deployment rules that map requirements of the application rule base to resources of the execution environment rule base. The deployment rules may be used in determining whether the set of computational resources satisfy the computational resource requirements.

In another embodiment of the present invention, a data processing arrangement includes a processor and a memory arrangement coupled to the processor. The memory arrangement contains at least one application and a bootstrap controller. The bootstrap controller is configured to cause the processor to determine computational resource requirements for execution of the application, determine a set of computational resources of the data processing arrangement that satisfy the computational resource requirements, and execute the application on the data processing arrangement if the computational resource requirements are satisfied.

In another embodiment of the present invention, a system includes: means for determining computational resources required for execution of a program; means for determining computational resources available via the system; means for determining a precondition based on whether the computational resources available via the system satisfy the computational resources required for execution of the program; and means for executing the program on the system if the precondition is satisfied.

In another embodiment of the present invention, a processor-readable medium includes a program storage device. The program storage device is configured with instructions for causing a processor of a data processing arrangement to: determine computational resources required for execution of an application program of the data processing arrangement; determine computational resources available via the data processing arrangement; determine a precondition based on whether the computational resources available via the data processing arrangement satisfy the computational resources required for execution of the application program; and execute the application program on the data processing arrangement if the precondition is satisfied.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates various aspects of an application execution environment according to embodiments of the present invention;

FIG. 2 illustrates an example data processing arrangement implementing a bootstrap controller according to embodiments of the present invention;

FIG. 3 illustrates details of a bootstrap controller and related components according to embodiments of the present invention;

FIG. 4 is a diagram illustrating a representative manner for providing execution environment-independent bootstrapping for applications in accordance with one embodiment of the invention;

FIG. 5 is a flow diagram illustrating application deployment in a bootstrap environment according to one embodiment of the invention; and

FIG. 6 is a flow diagram illustrating application execution in a bootstrap environment according to one embodiment of the invention.

### DETAILED DESCRIPTION OF THE INVENTION

In the following description of the exemplary embodiments, reference is made to the accompanying drawings, which form a part hereof, and in which is shown by way of illustration various manners in which the invention may be practiced. It is to be understood that other embodiments may be utilized, as structural and operational changes may be made without departing from the scope of the present invention.

Generally, the present invention provides a method and system for preparing and validating a run-time environment for computer application programs. In particular, a controller capable of “bootstrapping” applications utilizes a generic interface that can check an application's run-time requirements during the time the application is installed. The bootstrap controller can check the system environment each time thereafter that the application executes. The bootstrap controller can determine whether changes have occurred that will affect the application's capability to be executed, and make appropriate adjustments, if possible. In this way, the applications can be more easily and reliably installed into a system and run more robustly, even when the system environment changes.

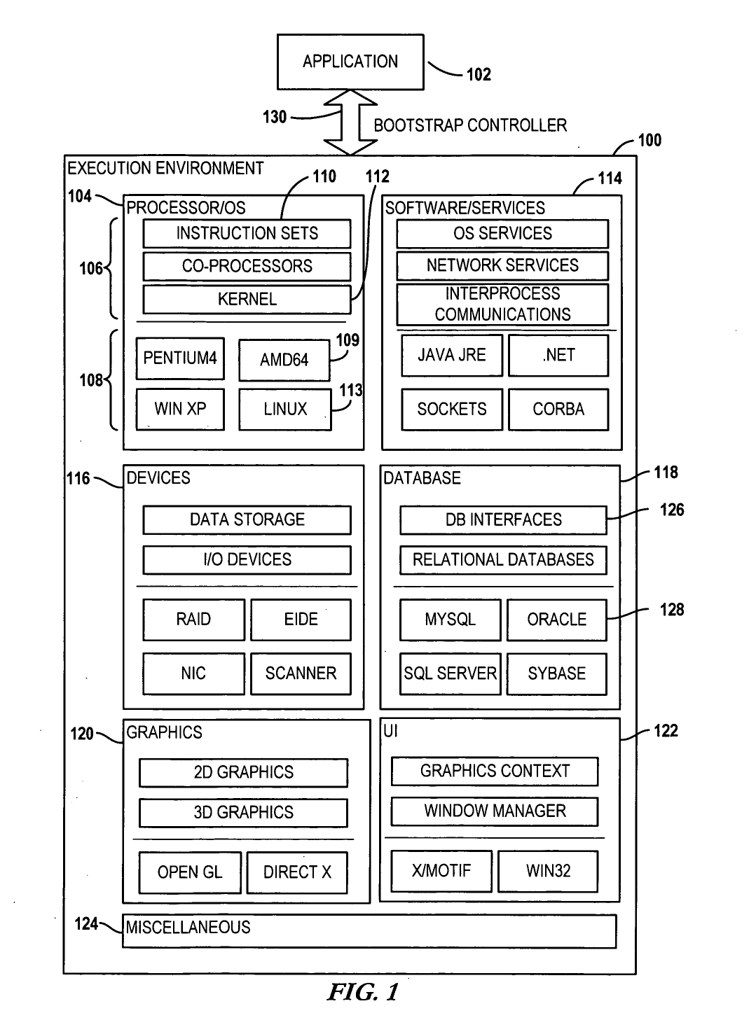

In general, most software applications are dependent on some aspects of an execution environment. This is illustrated in FIG. 1, which shows an exemplary software execution environment 100 according to embodiments of the present invention. The software execution environment 100 generally includes any software, hardware, system state, or any other pre-condition required for an application 102 (or “application program”) to execute. An application 102 refers to any machine executable instructions used to perform a task for an end-user. The end-user may be a person or another program. Generally, an application is considered distinct from an operating system and similar software. It will be appreciated, however, that some software has aspects of both operating system software and application software, and the present invention may be applicable to a wide range of computer programs.

The execution environment 100 is typically associated with at least a target processor and an operating system. Very simple programs, for instance, may require little more than the ability to allocate memory and a text-based interface for accepting input and presenting output. However, modern applications often rely on a wide variety of hardware, software, services, and other capabilities in the computing environment. Some of these capabilities and services are abstracted in FIG. 1.

Various aspects of the execution environment 100 may be placed in one or more categories. For example, one of the most elemental requirements of an application's execution environment 100 is the processor and operating system (OS) 104. As shown in FIG. 1 the processor/OS aspect 104 can be divided into abstractions 106 and instantiations 108. An abstraction 106 such as a processor instruction set 110 may have a particular instantiation 108 in the run-time environment, such as AMD64 109. Similarly, the abstraction of an OS kernel 112 may have an instantiation such as Linux 113.

The execution environment 100 of a modern computer system may have other components that are distinct from the processor/OS 104. These components may include software/services 114, devices 116, databases 118, graphics 120, user interfaces (UI) 122, and other components as represented by miscellaneous 124. In each of these components, abstract services or features provided by the component may have various instantiations. It will be appreciated that the categorization of components in the execution environment 100 is for purposes of illustration. Different organizations and categorizations may be equally valid and effective. For example, a database 118 may also be included as a software/service 114 component. Similarly, the graphics 120 and UI 122 components may have significant overlap.

In general, the application 102 may require any combination of components of the execution environment 100 in order to operate. The application may require a generic, abstract service, such as a generic database interface 126 that supports Structure Query Language (SQL) queries. In other situations, the application 102 may require a specific instantiation, such as an Oracle™ database 128. In either case, the application integrator typically must learn of these requirements and set-up the operating environment appropriately. These prerequisites may be communicated using documentation. However, documentation is notorious for becoming out of sync with the software, and documentation all too often contains erroneous information. Integrating a new application 102 is commonly a trial and error process because an application often has limited ways of informing the user of system prerequisites. Sometimes the end-user learns about missing prerequisites only when the software fails at runtime. This is especially true of smaller software projects, where documentation and integration is sometimes at the bottom of the priority list.

To solve these problems, the arrangement of FIG. 1 includes a bootstrap controller 130 that is designed to ease or eliminate application failures due to missing pre-requisites in the execution environment 100. The bootstrap controller 130 is a component that acts as an intermediary between the application 102 and the execution environment 100. The bootstrap controller 130 may be active at any time in the life cycle of the application 102, but is at least operative before the application 102 is executed. The bootstrap controller 130 may include interfaces to both the application 102 and the execution environment 100 so that the controller 130 can determine and resolve incompatibilities and/or insufficiencies of the execution environment 100.

Traditionally the applications 102 need to be aware of the execution environment 100 they are deployed within. Using the bootstrap controller 130, each execution environment 100 will provide adequate descriptions of capabilities of the environment 100 when applications 102 are deployed. This typically means that the application logic needs to take into account such factors as how and when the bootstrapping takes place, formats used to described the execution environment capabilities, formats for describing application requirements, error handling, etc. In this context the term “bootstrapping” is considered to involve those activities that are needed for an application 102 (e.g., a sequence of executable commands), to move from a “deployed” state to an “execution initiated” state, such that the application 102 is ready to perform subsequent state changes according to the application's pre-defined logic.

The bootstrapping phase is typically handled during a specific deployment or instrumentation phase. Incompatibilities at the deployment or instrumentation phase are additional sources of failure over and above those problems that may be encountered during application runtime. If the bootstrapping phase can be automated or taken care of by an infrastructure element such as the bootstrap controller 130, the probabilities for errors during the application life cycle can be reduced. Other advantages provided by a bootstrap controller include making the execution environment appear transparent to the applications 102, thus making software deployment easier and more predictable.

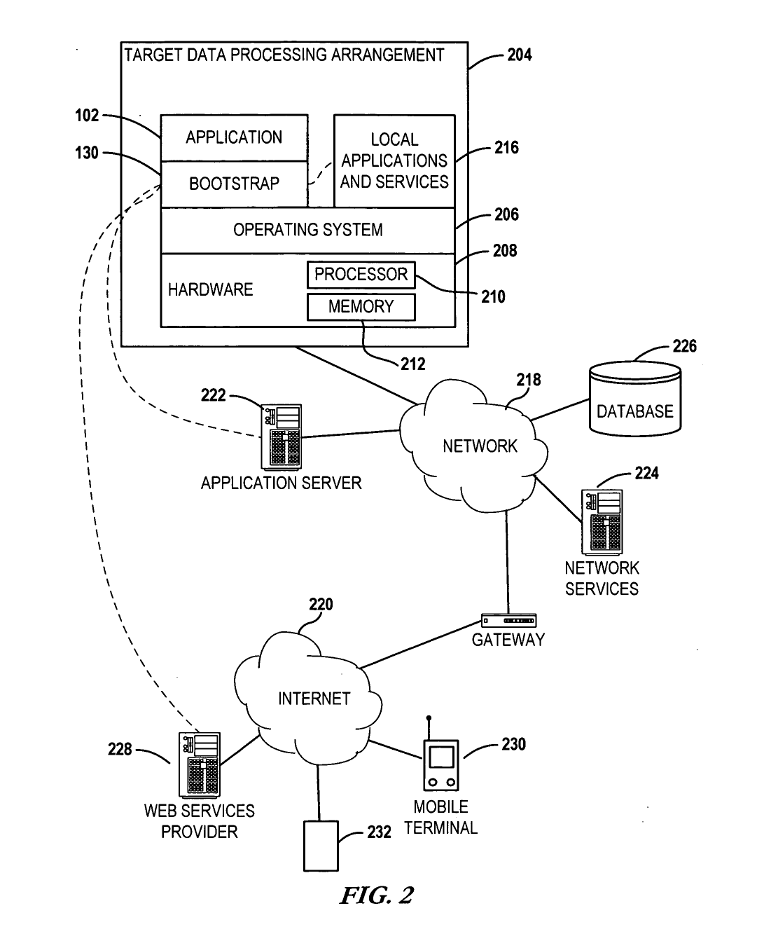

A more detailed example of a bootstrap controller according to embodiments of the present invention is shown in FIG. 2. Generally, an application 102 is deployed in a target data processing arrangement 204. The data processing arrangement 204 may be a single processor computer, multi-processor computer, distributed computing arrangement, clustered computer, or any other processing arrangement known in the art. For example, the bootstrap controller may be implemented in a mobile terminal 230. Any combination of hardware and software may be used to for the data processing arrangement 204, and the arrangement 204 may exist as an actual or virtual operating environment.

The data processing arrangement 204 generally includes an OS 206 and hardware 208 that includes at least one processor 210 and system memory 212. Any other combination of devices may be included with the hardware 208, including data input-output (I/O) busses, display output devices, input devices, network communications adapters, direct link communications adapters (e.g., parallel and serial busses), volatile memory storage (e.g. RAM), non-volatile solid state storage (e.g., NVRAM, flash memory), hard drives, removable magnetic media (e.g., floppy drives, tape), optical media (e.g., CD-ROM, DVD), and any other computer-interfaceable device known in the art.

A bootstrap controller 130 may provide pre-runtime communications with the application 102 and various elements of the arrangement 204, including the operating system 206, the hardware 208, and other applications and services 216 that are deployed locally on the arrangement 204. Communications between the bootstrap controller 130 and elements of the data processing arrangement 204 are for determining whether the data processing arrangement 204 includes an environment compatible with the deployed application 102. The bootstrap controller 130 may operate independently of the operating system 206. For example, the bootstrap controller 130 may be designed as a middleware component. It will be appreciated that the bootstrap controller 130 does necessarily need to be positioned to the same memory segment as the application 102 and other software components of the data processing arrangement 204. For example, the bootstrap controller 130 may be presented as a network service, and provide the boostrapping functionality remotely over a network 218.

The data processing arrangement 204 may be coupled to a local network 218 and/or to a wider network or system of networks such as the Internet 220. The availability of connectivity to the networks 218, 220 may be part of the system environment needed by the deployed application 102 and as determined by the bootstrap controller 130. Various network elements may provide services similar to the local application/services 216, and the deployed application 102 may also rely on the existence of these services. Services provided over the networks 218, 220 may include application servers 222 (e.g., distributed component object model servers, Java application servers), network services servers 224 (e.g., domain name services, directory services), databases 226, Web services servers 228 (e.g., Simple Object Access Protocol servers), and the like. It will be appreciated that any computing arrangement known in the art, as exemplified by the mobile terminal 230 and generic device 232, may also provide services to the data arrangement 204 and/or utilize a bootstrap controller as described herein.

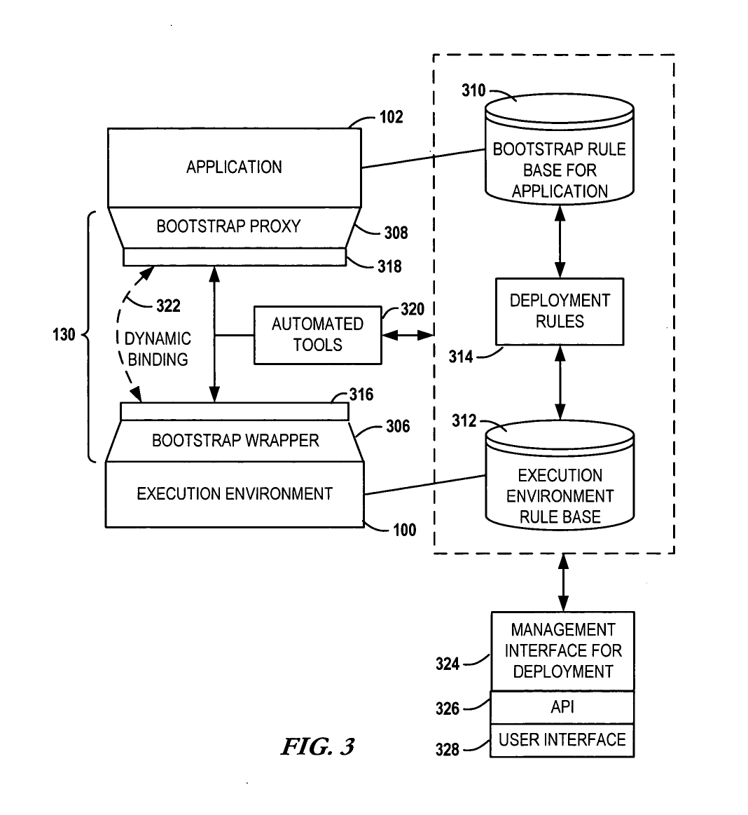

A particular implementation of a bootstrap controller 130 according to embodiments of the present invention is shown in FIG. 3. The bootstrap controller 130 is positioned logically between an application 102 and its execution environment 100. The bootstrapping controller 130 acts as a “vertical proxy layer,” thus ensuring that the application 102 always gets a uniform view of the execution environment 100. The arrangement of FIG. 3 may be distinguished from a traditional “container” approach (e.g,. Enterprise Java Beans container) in that the illustrated arrangement may be directed solely to application initiation, and thus may be implemented so as to minimize additional overhead. Furthermore, it may be assumed that initiation activities and other bootstrapping tasks can be arbitrated between the application 102 and the bootstrapping controller 130.

In the illustrated example, the bootstrap controller 130 may be divided into two parts: the bootstrap wrapper 306 and bootstrap proxy 308. The bootstrap wrapper 306 resides on top of the execution environment 100 and abstracts the capabilities of the execution environment 100. This abstraction is made visible to the application's bootstrapping proxy 308.

The execution environment 100 is responsible for provisioning the common capabilities of the underlying platform to the application 102. These capabilities may include database access, basic computing instructions, communications access, user interfaces routines, etc. The bootstrapping controller 130 provides platform-specific capabilities in a pre-determined manner during the bootstrapping process. In some configurations, this may mean that there is a pre-defined set of actions and or capabilities that all applicable execution environments must to fulfill in order to be compliant. The adoption of the required execution environment 100 is provided transparently to the application 102. From the application's point of view, it is mandatory that the required actions performed during bootstrapping are completed successfully. For example, part of the bootstrapping process may require that the bootstrap controller 130 create a specific set of database tables in a system database or create a set of user files. If the required actions have not been taken or completed successfully, the bootstrap controller 130 returns to the caller without starting the actual application 102, provided that this mode of error handling is defined accordingly in the application logic.

Among other things, the present invention involves providing a set of pre-defined actions that occur during application bootstrap so that application 102 can be sure that the required preliminary actions have been successfully performed. The pre-defined actions required by the application 102 towards the proxies are described in the form of rules in an application specific rule base 310. These rules in the application rule base 310 are abstracted in a format that is useful to the application 102. For example, an application 102 may require one or more generically defined services, and the execution environment 100 may have a number of specific services that can fulfill those requirements. Generally, there will exist a logical relation between the application rule base 310 and an execution environment rule base 312 that describes the features and services available from the execution environment 100. These relationships can be described as a set of deployment rules 314 that describe what the bootstrapping proxy 308 needs to provide to the application 102 during the bootstrapping phase. The deployment rules 314 translate the application requirements into the specific available features and services described in the execution environment rule base 312. The deployment rule base 312 may be generated automatically for each application 102 using automated tools 320.

When the application 102 is first deployed in the execution environment 100, the automated tools 320 are used to analyze the application rule base 310 against the execution environment rule base 312 to determine the deployment rules 314 that map between the two rule bases 310, 312. These deployment rules 314 may be used for communications between the bootstrap wrapper 306 and bootstrap proxy 308. To facilitate these communications, the bootstrap wrapper 306 provides an interface 316 to the bootstrap proxy 308. The bootstrap proxy 308 may also include its own interface 318 for communicating with the bootstrap wrapper 306. The deployment rules 314 are generally configured provide the means for expressing the abstractions applied by the interfaces 316 and 318.

The interfaces 316, 318 may be generic or may be tailored by the automation tools 320 to suit a particular combination of application 102 and execution environment 100. The interfaces 316, 318 may be implemented as a set of common APIs accessible by the application 102 and/or execution environment 100. The APIs may be implemented as function calls in a system library. If the bootstrap controller 130 is implemented as a network service, the interfaces 316, 318 may be provided via a remote invocation interface.

The bootstrap controller 130 acts to enforce a contract between the application 102 and execution environment 100 in the form of the bootstrap proxy 308 and bootstrap wrapper 306. This involves utilizing the respective rule bases 310, 312 of the application 102 and execution environment 100, as well as the automated tools 320 associated with these rules bases 310, 312. The bootstrap controller 130 keeps track of bootstrapped applications and their bootstrapping requirements that are made available at least at the time of application deployment. The bootstrap controller 130 may reject bootstrapping under certain conditions, such as when the underlying execution environment 100 is not capable of providing the mandatory set of application requirements. These requirements may be flagged as mandatory by the application 102 and/or the application rule base 310.

An initial message exchange interface occurs between the application 102 and bootstrap controller 130 in order to provide a uniform set of preconditions to the application 102 during the bootstrap process. Similarly, a uniform description of application acknowledgements of bootstrap process completion is provided for the bootstrap controller 102. The preconditions and acknowledgements may be expressed using predefined rules adopted by the interfaces 316, 318 between the bootstrap wrapper 306 and the bootstrap proxy 308. After the initial deployment of the application 102, the bootstrap proxy 308 is able to utilize a dynamic binding 322 at runtime via the bootstrap wrapper interface 316. The interfaces 316, 318 between the bootstrap wrapper 306 and the bootstrap proxy 308 can be unified across different execution environments 100. In a simple form, this binding 322 of interfaces 316, 318 may be implemented as a procedure/function invocation on a homogeneous processing environment. In other arrangements, the dynamic binding 322 may be made across heterogeneous binary formats and multiple network segments and types.

Generally, the bootstrap controller 130 can be distributed between the application 102 and the execution environment 100 to allow the dynamic binding 322 to work across different combinations of bootstrap proxies 308 and bootstrap wrappers 306 based on characteristics of varying execution environments 100. The bootstrap controller 130 scans the appropriate rule bases 310, 312 in order to ensure that the applied environment specific rules 314 are incorporated to the application bootstrap process. The application rule base 310 is used for ensuring that the bootstrapping is executed according to the capabilities of the underlying execution environment 100. The application rule base 310 can be used to guide the advancement of bootstrapping process (especially with respect to applications 102 loading to memory) with respect to the status of the environment 100.

The illustrated arrangement may also include a management interface 324. The management interface 324 may utilize simple controls such as initialization files and logging files for input and output. The management interface 324 may also include an application program interface (API) 326 and/or user interface 328. The API 326 and user interface 328 allow aspects of the bootstrapping process, such as the deployment rules 314 and rule bases 310, 312, to be seen and managed. The user interface 328 may provide user access for such purposes as system administration. The API 326 is generally used by to provide programmatic access to the bootstrap controller 130 and related components. For example, the API 326 may be accessed by programs designed to manage bootstrapping functionality and/or provide other functions such as software installation.

When underlying execution environments 100 are rich in resources (e.g., available RAM), applications 102 can be positioned in the memory in a pre-bootstrapped configuration. In such a scenario, the bootstrapping process can be seen as primarily part of the deployment process, and bootstrapping of individual applications may only need occur during system boot-up. This may be useful in application types that require fast startup response for the first invocation of the application 102. In resource-scarce environments, partial pre-loading (preliminary bootstrapping) can be performed in order to minimize the memory and other resource needs. Note that the bootstrapping control and its phasing is most naturally done via the applicable bootstrap rule base 310.

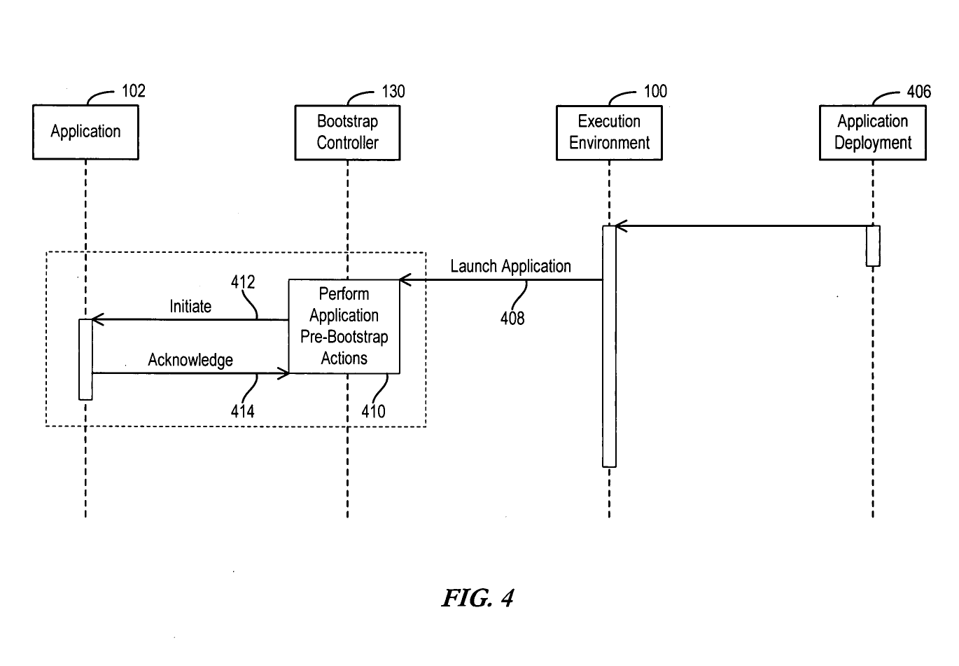

In reference now to FIG. 4, the deployment of a bootstrap controller is shown according to one embodiment of the invention. In the illustrated embodiment, the bootstrap controller 130 is logically positioned between the application 102 and the execution environment 100. Upon application deployment 406 in an execution environment 100, the execution environment 100 initiates the launching 408 of the application. The application execution environment 100 provisions the common service-oriented capabilities of the underlying platform to the application. The bootstrap controller 130 serves as a contract between the application 102 and the execution environment 100, and keeps track of bootstrapped applications and their bootstrapping requirements, which are available via application deployment 406.

The bootstrap controller 130 provides platform-specific capabilities in a predetermined manner, such that there is a predefined set of actions that the application execution environments 100 need to fulfill, and the adoption of such actions is non-transparent to the application. Thus, the bootstrap controller 130 performs application pre-bootstrap actions 410, and initiates 412 the application. An initial message exchange interface is introduced between the application 102 and bootstrap controller 130 in order to provide the uniform set of pre-conditions to the application 102 during the bootstrap process. A uniform description is provided on application acknowledgement 414 of the completion of the bootstrap process to the bootstrap controller 130.

The introduction of the bootstrap controller 130 provides controllability and makes applications receive in their class a homogeneous input for bootstrapping. Where standardized across different technologies, such a bootstrap controller may introduce value to application portability, especially in the application server side as it provides one more neutralization point.

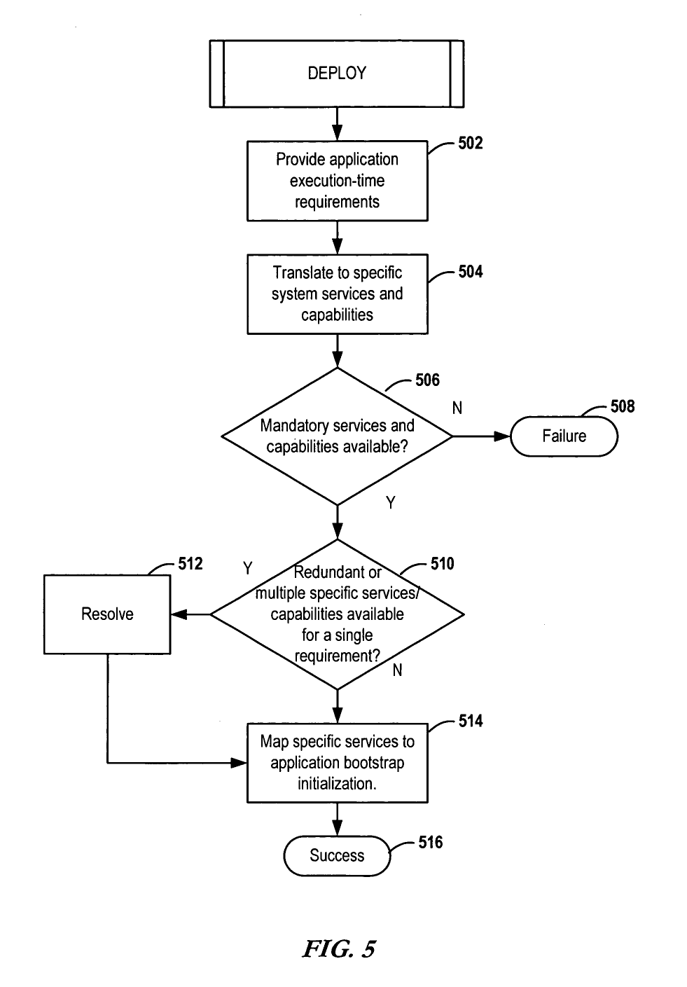

In reference now to FIG. 5, an example procedure is shown for preparing a bootstrap controller at deployment-time according to embodiments of the present invention. Initially, the execution time requirements of the application must be provided 502. These requirements may be provided 502, for example, by examining an application bootstrap rule base using one or more automated tools. The application may also be enabled to provide 502 these requirements through configuration files or an installation program provided with the application. The application requirements are translated 504 to specific services and capabilities available in the deployed platform. This translation 504 may, for example, involve forming a set of deployment rules usable by an application and/or bootstrap controller during application startup. If it is determined 506 that all mandatory services and capabilities are not available, then the routine should exit with a failure 508.

If the mandatory services are available, then the bootstrapping process may also determine 510 whether there are redundant services or capabilities available. If redundant services/capabilities are available, then the bootstrapping rules will resolve 512 how these redundancies are dealt with. For example, a single service may be chosen where there are more than one equally desirable alternatives. In some cases, the bootstrapping rules may also resolve 512 redundancies by determine a priority at runtime. This may be useful, for example, for identical services that are available at different network nodes. A primary node may be chosen, but if the primary node is not available, a secondary node may be used.

Finally, the bootstrapping rules may be used to map 514 the environmental services to the application. This mapping 514 may occur, for example, by forming bootstrap proxy and bootstrap wrapper interfaces as shown in FIG. 3. The rules that are part of the mapping and/or these interfaces may be stored in a database and used for future bootstrapping operations. Assuming that the mapping 514 is successful, the routine can exit successfully 516.

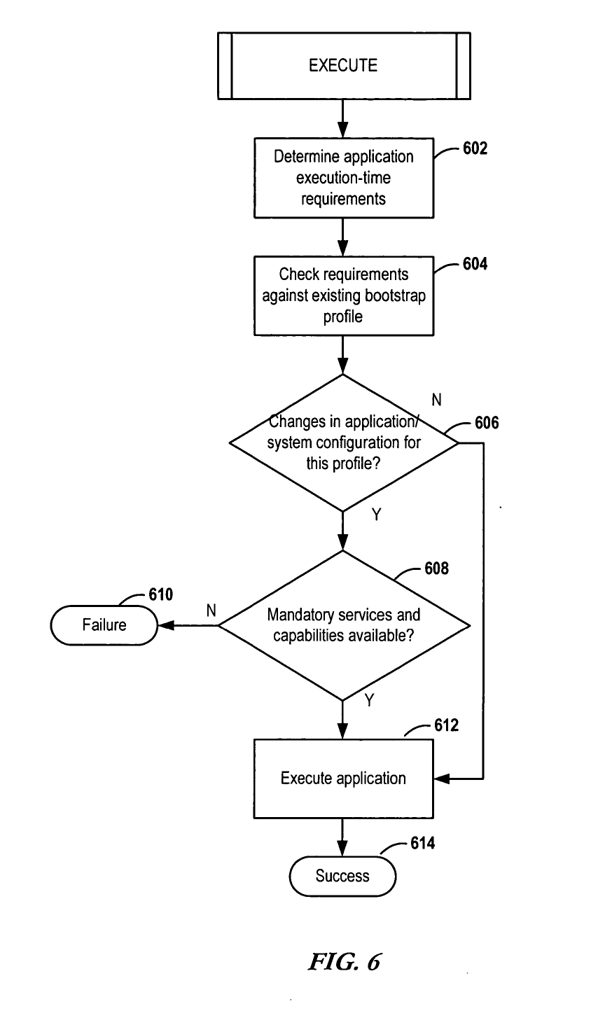

It will be appreciated that the example procedure shown in FIG. 5 may be performed just once or every time an application executes. After initial deployment of the application, it may be more efficient to utilize stored bootstrapping rules for starting the application with a bootstrap controller. An example procedure for starting applications according to embodiments of the present invention is shown in FIG. 6.

The procedure in FIG. 6 begins by determining 602 execution time requirements of an application. The requirements may be determined, for example, by querying a bootstrapping rule base associated with the application. In other configurations, the application and/or the bootstrapping environment may provide an API to determine run-time capabilities before starting the application. The application requirements are then checked 604 against system environment, and it is determined 606 whether there have been changes to the system or application. In some situations, the application requirements and/or system environment may have changed between invocations of an application. For example, the application may have been upgraded or reconfigured so that new services/capabilities are needed and/or existing services/capabilities are no longer required. In other situations, the execution environment may no longer have available mandatory services/capabilities, and may have added new capabilities that may be used as alternates by the application.

If it has been determined 606 that there have been environment or application changes, it must then be determined 608 whether mandatory services/capabilities needed by the application are available. This determination 608 may be performed, by example, using the procedure shown in FIG. 5. If the execution environment cannot provide mandatory services/capabilities, the procedure exits 610 without proceeding further. If there were no changes or if changes did not remove mandatory services/capabilities, then the application can be executed 612 and the routine finishes 614 successfully.

Using the description provided herein, the invention may be implemented as a system, machine, process, and/or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the invention. As such, the terms “article of manufacture” and “computer program product” as used herein are intended to encompass a computer program that exists permanently or temporarily on any computer-usable medium or in any transmitting medium which transmits such a program.

Memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links.

From the description provided herein, those skilled in the art are readily able to combine software created as described with appropriate general purpose or special purpose computer hardware to create a computer system and/or computer subcomponents embodying the inventive subject matter, and to create a computing system and/or computer subcomponents for carrying out the invention.

The foregoing description of the exemplary embodiments of the invention have been presented for the purposes of illustration and description. It is not intended to be exhaustive or to limit the invention to the precise form disclosed. Many modifications and variations are possible in light of the above teaching.

1. A method of initiating execution of an application program on a data processing arrangement, comprising:
determining computational resources required for execution of the application program;
determining computational resources available via the data processing arrangement;
determining a precondition based on whether the computational resources available via the data processing arrangement satisfy the computational resources required for execution of the application program; and
executing the application program on the data processing arrangement if the precondition is satisfied.

2. The method of claim 1, further comprising registering the computational resources available via the data processing arrangement in an execution environment rule base.

3. The method of claim 2, further comprising registering the computational resources required for execution of the application program in an application rule base.

4. The method of claim 3, further comprising forming deployment rules that map requirements of the application rule base to resources of the execution environment rule base, and wherein determining the preconditions further comprises applying the deployment rules to the execution environment rule base and the application rule base.

5. The method of claim 1, further comprising registering the computational resources required for execution of the application program in an application rule base.

6. The method of claim 1, wherein determining the computational resources required for execution of the application program further comprises utilizing a proxy interface of the application program, the proxy interface providing predefined rules for describing computational resources required for execution of the application program.

7. The method of claim 6, wherein determining the computational resources available via the data processing arrangement further comprises utilizing a wrapper interface of the data processing arrangement, the wrapper interface providing predefined rules for describing computational resources available via the data processing arrangement.

8. The method of claim 7, wherein determining the precondition comprises communicating between the proxy interface of the application program and the wrapper interface of the data processing arrangement to determine whether the computational resources available via the data processing arrangement satisfy the computational resources required for execution of the application program.

9. The method of claim 8, wherein communicating between the proxy interface of the application program and the wrapper interface of the data processing arrangement comprises creating a dynamic binding between the proxy interface and the wrapper interface prior to execution of the application program.

10. The method of claim 1, wherein determining the computational resources available via the data processing arrangement further comprises utilizing a wrapper interface of the data processing arrangement, the wrapper interface providing predefined rules for describing computational resources available via the data processing arrangement.

11. The method of claim 1, wherein the computational resources required for execution of the application program comprise at least one of a processor type, an operating system, data communications primitives, a database, and a user interface.

12. A system, comprising:
at least one application;
a plurality of computational resources; and
a bootstrap controller that performs operations including,
determining computational resource requirements for execution of the application;
determining a set of computational resources that satisfy the computational resource requirements from the plurality of computational resources; and
executing the application on the system if the computational resource requirements are satisfied.

13. The system of claim 12, further comprising:
an execution environment rule base describing the plurality of computational resources;
an application rule base describing the computational resource requirements for execution of the application; and
wherein the bootstrap controller is further configured to form deployment rules that map requirements of the application rule base to resources of the execution environment rule base, the deployment rules used in determining whether the set of computational resources satisfy the computational resource requirements.

14. The system of claim 12, wherein the bootstrap controller utilizes a proxy interface of the application, the proxy interface providing predefined rules for describing computational resources required for execution of the application.

15. The system of claim 14, wherein the bootstrap controller utilizes a wrapper interface, the wrapper interface providing predefined rules for describing computational resources available via the system.

16. The system of claim 15, wherein the bootstrap controller utilizes communications between the proxy interface of the application and the wrapper interface of the data processing arrangement to determine whether the set of computational resources that satisfy the computational resource requirements.

17. The system of claim 16, wherein communicating between the proxy interface of the application and the wrapper interface of the data processing arrangement comprises creating a dynamic binding between the proxy interface and the wrapper interface prior to execution of the application.

18. The system of claim 12, wherein the bootstrap controller utilizes a wrapper interface, the wrapper interface providing predefined rules for describing computational resources available via the system.

19. The system of claim 12, wherein the computational resources required for execution of the application comprise at least one of a processor type, data communications primitives, a database, and a user interface.

20. A data processing arrangement, comprising:
a processor; and
a memory arrangement coupled to the processor and containing at least one application and a bootstrap controller, wherein the bootstrap controller is configured to cause the processor to,
determine computational resource requirements for execution of the application;
determine a set of computational resources of the data processing arrangement that satisfy the computational resource requirements; and
execute the application on the data processing arrangement if the computational resource requirements are satisfied.

21. The data processing arrangement of claim 20, further comprising:
an execution environment rule base describing the plurality of computational resources;
an application rule base describing the computational resource requirements for execution of the application; and
wherein the bootstrap controller is further configured to form deployment rules that map requirements of the application rule base to resources of the execution environment rule base, the deployment rules used in determining whether the set of computational resources satisfy the computational resource requirements.

22. The data processing arrangement of claim 20, wherein the bootstrap controller utilizes a proxy interface of the application, the proxy interface providing predefined rules for describing computational resources required for execution of the application.

23. The data processing arrangement of claim 22, wherein the bootstrap controller utilizes a wrapper interface, the wrapper interface providing predefined rules for describing computational resources available via the data processing arrangement.

24. The data processing arrangement of claim 23, wherein the bootstrap controller utilizes communications between the proxy interface of the application and the wrapper interface of the data processing arrangement to determine whether the set of computational resources that satisfy the computational resource requirements.

25. The data processing arrangement of claim 24, wherein communicating between the proxy interface of the application and the wrapper interface of the data processing arrangement comprises creating a dynamic binding between the proxy interface and the wrapper interface prior to execution of the application.

26. The data processing arrangement of claim 20, wherein the bootstrap controller utilizes a wrapper interface, the wrapper interface providing predefined rules for describing computational resources available via the data processing arrangement.

27. The data processing arrangement of claim 20, wherein the computational resources required for execution of the application comprise at least one of a processor type, data communications primitives, a database, and a user interface.

28. A system comprising:
means for determining computational resources required for execution of a program;
means for determining computational resources available via the system;
means for determining a precondition based on whether the computational resources available via the system satisfy the computational resources required for execution of the program; and
means for executing the program on the system if the precondition is satisfied.

29. The system of claim 28, further comprising means for registering the computational resources available via the system for future retrieval.

30. The system of claim 28, further comprising means for registering the computational resources required for execution of the program for future retrieval.

31. The system of claim 28, further comprising means for creating a dynamic binding between a first interface of the program and a second interface of the system, the first interface providing predefined rules for describing computational resources required for execution of the program, and the second interface providing predefined rules for describing computational resources available via the system.

32. A processor-readable medium, comprising:
a program storage device configured with instructions for causing a processor of a data processing arrangement to perform the operations of,
determining computational resources required for execution of an application program of the data processing arrangement;
determining computational resources available via the data processing arrangement;
determining a precondition based on whether the computational resources available via the data processing arrangement satisfy the computational resources required for execution of the application program; and
executing the application program on the data processing arrangement if the precondition is satisfied.

33. The processor-readable medium of claim 32, wherein the operations further comprise registering the computational resources available via the data processing arrangement in an execution environment rule base.

34. The processor-readable medium of claim 33, wherein the operations further comprise registering the computational resources required for execution of the application program in an application rule base.

35. The processor-readable medium of claim 34, wherein the operations further comprise forming deployment rules that map requirements of the application rule base to resources of the execution environment rule base, and wherein determining the preconditions further comprises applying the deployment rules to the execution environment rule base and the application rule base.

36. The processor-readable medium of claim 32, wherein the operations further comprise registering the computational resources required for execution of the application program in an application rule base.

37. The processor-readable medium of claim 32, wherein determining the computational resources required for execution of the application program further comprises utilizing a proxy interface of the application program, the proxy interface providing predefined rules for describing computational resources required for execution of the application program.

38. The processor-readable medium of claim 37, wherein determining the computational resources available via the data processing arrangement further comprises utilizing a wrapper interface of the data processing arrangement, the wrapper interface providing predefined rules for describing computational resources available via the data processing arrangement.

39. The processor-readable medium of claim 38, wherein determining the precondition comprises communicating between the proxy interface of the application program and the wrapper interface of the data processing arrangement to determine whether the computational resources available via the data processing arrangement satisfy the computational resources required for execution of the application program.

40. The processor-readable medium of claim 39, wherein communicating between the proxy interface of the application program and the wrapper interface of the data processing arrangement comprises creating a dynamic binding between the proxy interface and the wrapper interface prior to execution of the application program.

41. The processor-readable medium of claim 32, wherein determining the computational resources available via the data processing arrangement further comprises utilizing a wrapper interface of the data processing arrangement, the wrapper interface providing predefined rules for describing computational resources available via the data processing arrangement.

42. The processor-readable medium of claim 32, wherein the computational resources required for execution of the application program comprise at least one of a processor type, an operating system, data communications primitives, a database, and a user interface.
